(19) United States
(12) Patent Application Publication
(10) Pub. No.: US 2004/0091586 A1
(43) Pub. Date: May 13, 2004

(54) Cellulose-hydrate-containing food casing with vinylpyrrolidone polymers

(76) Inventors: Klaus-Dieter Hammer, Mainz (DE); Herbert Gord, Ingelheim (DE); Rainer Neeff, Wiesbaden (DE)

Correspondence Address: CONNOLLY BOVE LODGE & HUTZ LLP, SUITE 800, 1990 M STREET NW, WASHINGTON, DC, 20036-3425, US

(21) Appl. No.: 10/695,941

(22) Filed: Oct. 30, 2003

(30) Foreign Application Priority Data
Nov. 4, 2002 (DE) 10251200.0

(51) Int. Cl. A23G 1/00

(52) U.S. Cl. 426/135

(57) ABSTRACT

The invention relates to a cellulose-hydrate-containing seamless tubular food casing comprising at least one vinylpyrrolidone homopolymer and/or vinylpyrrolidone copolymer in admixture with the cellulose hydrate. The weight ratio of vinylpyrrolidone homopolymer and/or vinyl-pyrrolidone copolymer to cellulose is generally from 1:25 to 10:1. The casing can be reinforced with fibers, in particular with a hemp fiber paper. It is generally produced by the viscose process and has a low permeation and anti-mold properties. The casing is envisaged as artificial sausage casing, particularly suitable for dry or long-keeping sausage.

### CLAIM FOR PRIORITY

The present invention claims priority under 35 U.S.C. § 119 from German Patent Application DE 102 51 200.0 filed Nov. 4, 2002, the content of which is incorporated herein by reference in its entirety.

### BACKGROUND OF THE INVENTION

1. Field of the Invention

The present invention relates generally to cellulose-hydrate-containing seamless tubular food casings and to processes for production thereof.

2. Description of Related Art

The production of sausage skins from cellulose hydrate has long been known. It is predominantly carried out to date by the viscose process wherein cellulose in the form of pulp is mercerized by a sodium hydroxide solution. The resultant alkali metal cellulose is then reacted with carbon disulfide (CS₂) to give cellulose xanthogenate and this product is generally referred to as viscose. After aging for several days, the viscose is forced under pressure through an annular die into a precipitation bath. In the precipitation bath, the viscose is converted to cellulose hydrate. The cellulose hydrate gel tube then passes through further precipitation and wash baths and is finally, washed, dried and usually also furnished with a secondary plasticizer, such as glycerol according to customary procedures.

Furthermore, the addition of various additives to the viscose is known, and these additives are typically employed to modify the properties of the cellulose hydrate casings. These include aqueous dispersions of (C₁₀-C₂₅)alkyltrimethylolurea, of (C₁₀-C₂₅)alkylaminebisdimethylenetriazinonetetramethylol (DE 23 62 770) or of (C₁₂-C₂₀)alkylethyleneurea (DE 23 62 606).Esters of aliphatic (C₁₀-C₂₄)monocarboxylic acids with diols (such as polyethylene glycol) or with polyols (such as glycerol) can also be added to the viscose (DE 26 54 427) and function as primary (permanently acting, non-extractable) plasticizers.

By adding alginic acid and/or alginate to the viscose, cellulose casings having increased hydrophilicity may be obtained (DE 40 02 083). In addition, as additives, copolymers with units of vinylpyrrolidone and units of (meth)acrylates which have tertiary ammonium groups are often used. Copolymers of this type are available, for example, under the name ®Gafquat from GAF Corp. The copolymers reduce the permeation, which, in particular, leads to an improvement in the ripening of long-keeping or “dry” sausage (EP-A 635 212). If fats, fat-like compounds or oils are also added in addition to alginic acid and/or alginate, casings are obtained which generally no longer need to be treated with a secondary (=temporary, extractable with water) plasticizer, such as glycerol (EP-A 638 241). Still other additives have the purpose of increasing the toughness of the dry cellulose.

In these above-described use of additives, the purpose was an attempt to improve the properties of the cellulose hydrate in order to better adapt casings produced therefrom to conditions occurring during the process. In known casings, cellulose hydrate, has always been the dominant component in terms of total overall content and properties of the casing. Thus, the adverse properties of cellulose, such as their inherent susceptibility to enzymatic breakdown by cellulases, excessive shrinkage, compaction and embrittlement of the cellulose hydrate, remain problematic and have not been adequately compensated for.

In addition, there have been efforts to make the production process for fiber-reinforced cellulose casings more expedient and more environmentally friendly by increasing the spinning speed. According to DE 195 10 883, this was achieved by decreasing the amount of viscose deposited per unit area. However, if the amount of viscose is reduced by more than from 20 to 25%, the course of spinning is impaired and the yield decreases. Furthermore, in such processes, the clips used for closing the sausage ends do not sit firmly. As such, the casings then become susceptible to shear. Reducing weight and thickness also increases the permeation, but this results in an impairment of the suitability of the casings to be used for long-keeping sausage products, in particular for mold-ripened long-keeping sausage. Long-keeping or dry sausage is a sausage which is air-dried and ripened at ambient temperatures for a period of several weeks to several months and, optionally, smoked. Dry sausages, of which the various salami and cervelats are prime examples, are typically not cooked or scalded or otherwise heat-treated.

### SUMMARY OF THE INVENTION

These deficiencies as described above gave rise to at least one object of the present invention which was to produce cellulose casings in an expedient and environmentally friendly manner, while keeping the amount of viscose as low as possible (which, in particular, keeps the gas formation relatively low during regeneration of the cellulose). Casings are to have a permeability so low that they are also suitable for air-ripened long-keeping sausage.

These and other objects can be achieved, for example, by mixing viscose with a vinylpyrrolidone homopolymer or copolymer (hereinafter called PVP). In this manner adverse cellulose properties may successfully be reduced, while at the same time, the spinning process is successfully improved.

The invention therefore relates to a cellulose-hydrate-containing seamless tubular food casing comprising at least one vinylpyrrolidone homopolymer and/or copolymer in admixture with cellulose hydrate. The present invention is further directed to processes of manufacture and use of such casings including shirred sticks and food products and associated methodology.

Additional objects, features and advantages of the invention will be set forth in the description which follows, and in part, will be obvious from the description, or may be learned by practice of the invention. The objects, features and advantages of the invention may be realized and obtained by means of the instrumentalities and combination particularly pointed out in the appended claims.

### DETAILED DESCRIPTION OF A PREFERRED EMBODIMENT

The weight ratio of vinylpyrrolidone homopolymer and/or copolymer to cellulose is preferably generally from 1:25 to 10:1, more preferably from 1:5 to 5:1, and particularly preferably in some embodiments from 1:4 to 4:1. The proportion is preferably chosen in such a manner that the casing is rendered or maintained resistant to cellulase, or is at least less susceptible to cellulase. Cellulase can be formed, for example, by mold and other microorganisms.

The comonomer units in the vinylpyrrolidone copolymers can be any desired, and in particular, in some embodiments comprise units of vinyl alcohol derivatives, especially vinyl esters (such as vinyl acetate) and vinyl ethers (such as vinyl methyl ether or vinyl ethyl ether). In addition, units of conjugated dienes (such as butadiene or isoprene), of acrylamide or of α,β-ethylenically unsaturated carboxylic acids (such as acrylic acid, methacrylic acid or itaconic acid) can be employed if desired. In addition to vinylpyrrolidone units, the copolymer can also contain two or more different comonomer units. The proportion of comonomer units utilized can depend, for example, on whether the comonomor units are more polar or apolar, as well as on any other desired criteria. Any proportion of comonomor units can be employed. In general, the proportion of comonomer units is preferably less than about 50 mol %, more preferably less than about 30 mol %.

In a particular embodiment, the food casing comprises a fiber reinforcement, in particular a reinforcement of hemp fiber paper. The fiber reinforcement is preferably shaped to form a tube, and is charged from the inside, from the outside or from both sides with a mixture of viscose and vinylpyrrolidone homopolymer and/or copolymer. The inventive fiber-reinforced casing can comprise a casing which is viscose-coated on the outside, inside or on both sides. In the case of the casing which is viscose-coated on both sides, preferably only the outer cellulose hydrate layer contains PVP.

PVP homopolymers can be used having various mean (or average) molecular weights M_{w} (M_{w} preferably from about 1000 to about 5,000,000, more preferably from 10,000 to 1,500,000). The PVP homopolymers, and/or vinylpyrrolidone copolymers which are specified in more detail hereinafter, are generally not crosslinked, but can be crosslinked if necessary or desired. PVP homopolymers, and/or vinylpyrrolidone copolymer types which have proven advantageous include those which, at a solids content of about 7% by weight(which is the solids content of viscose), achieve a comparable viscosity to an aqueous solution and are generally pumpable and mixable without substantial problems. Preferably PVP-K90 (from GAF Corporation) a polyvinylpyrrolidone having a mean molecular weight of about 630,000 is one suitable example. Such a polymer can generally be easily handled at a strength of between 6 and 9% by weight. At higher concentrations, PVP-K60 (from 8 to 11% by weight) may be used, and at lower concentrations, PVP K 120 (from 4 to 6% by weight). Using a 7% strength by weight of PVP-K90 solution, from 2 to 80% by weight, preferably from 10 to 60% by weight, of viscose may generally be replaced without problem. PVP-K90, K60 and K120 are merely exemplary and any desired material could be substituted if desired. The PVP solution can be added to the viscose, for example, just upstream of the spinneret and the PVP solution is preferably mixed uniformly.

During the spinning process, the PVP precipitates out together with the cellulose. With increasing PVP proportion, the regeneration of the remaining cellulose xanthogenate accelerates, gas formation accelerates accordingly. If the bath composition is unchanged, this increased gas formation can only be compensated for by increasing the velocity. After velocity or bath correction, the tubes are considerably more stable and run more uniformly than those without PVP addition.

Owing to its enhanced accessibility, the regeneration of the remaining cellulose xanthogenate is, completed considerably faster than cellulose that has not been admixed with PVP. That is to say, a dense membrane does not form on the outside or inside of the tubular casing and hence, regeneration is improved. The gas formation in the precipitation vats is considerably less while the cutting time is significantly extended as a result. In addition, due to decreased interaction between the molecules, shrinkage is reduced, thereby favourably improving, tension conditions during transport of tubes that are in a laid-flat condition.

Replacing the cellulose hydrate by PVP not only leads to an improved run of the casing, even at relatively high velocity, but the use of PVP also has the decisive advantage that the unpleasant gaseous and dissolved by-products of the cellulose xanthogenate are correspondingly reduced. In addition, the PVP gives the sausage casings a great number of unusual properties which had not been achievable to date, such as (i) lower permeation while water vapor permeability is preserved, (ii) reduced susceptibility to cellulase due to reduced cellulose proportion and, indirectly, to mold resistance, which, with increasing amount added, leads to complete mold suppression in inoculated sausages, and (iii) the PVP gives the sausage casings an affinity to the sausage-meat emulsion.

The higher the PVP proportion selected, the lower the precipitation and wash capacity generally required in the spinning process. That is to say, the number of vats can be decreased, which likewise has a favorable effect on the production process.

At the end of the spinning process the laid-flat tubes generally pass through a plasticizer vat which likewise can be partially or completely utilized. Namely, the tubes can be treated so as to take up a conventional (from 20 to 22% by weight) glycerol content, or a reduced (less than 20% by weight) glycerol content as desired.

The inventive food casing can also be produced by numerous other processes, for example by the NMMO process. This is because vinylpyrrolidone (co)polymers (in particular those not having an excessive molecular weight) are soluble (as is cellulose) in N-methylmorpholine N-oxide (NMMO)/water mixtures (in particular in NMMO monohydrate). The NMMO/water mixture together with the components dissolved therein can generally be extruded through an annular die into a precipitation bath, where the cellulose and the vinylpyrrolidone polymers are precipitated out. The tubular casing formed is then typically washed and dried, and if appropriate, also treated with a secondary plasticizer, in any manner familiar to those skilled in the art.

It is of interest that the permeation decreases in proportion with the amount of PVP, even with full glycerol content, conventional weight and usual thickness. For example the permeation can decrease from 100 l/m²d at 40 bar at 0% PVP to 64 l/m²d at 35% PVP. As a result of the decreased permeation, the inventive casings are particularly suitable for ripening long-keeping dry sausage. For mold-ripened sausages, in contrast, they may not be as suitable, at a content of more than about 10% PVP by weight, based on the dry weight of the casing, even after inoculation with refined mold cultures, mold growth is suppressed, and the mold grows only in points and/or in an isolated manner. At PVP contents of 20% by weight or more, the growth may be prevented completely.

To date it was not known that PVP inhibits mold growth, that is to say, indirect cellulase protection can be achieved for adding a sufficient quantity of PVP, for example, 5% or greater. Providing a PVP coating on the surface of a PVP-free cellulose hydrate casing, in contrast, surprisingly has only very low activity in terms of mold supression. It is also unusual that with increasing PVP content, the permeation decreases, but the water vapor permeability remains unchanged (1500 to 2000 g/m²d). The ripening of long-keeping or dry sausage is retarded as a result in the first, critical phase. As such, dry rims can be prevented; and thereafter, rapid moisture release takes place.

The protein-like properties of PVP give the casings a marked affinity to the sausage-meat emulsion, even at contents of slightly less than or about 10% by weight, and give a peelability of 1.5 (rating scale from 1 to 6:1=very readily peelable; 6=no longer peelable without destruction). Conventional protein impregnation generally only provides a peelability increase in casings having an outer viscose coating to a level from 2 to 2.5. If appropriate, the inventive casing can be provided on the inside with one of the conventional adhesion impregnations according to those known by one of skill in the art. Suitable adhesion components are disclosed e.g. in U.S. Pat. No. 5,595,796 which is incorporated herein by reference in its entirety.

By optionally impregnating the inner and/or outer surface with a PVP-containing aqueous solution, the properties of the inventive casing may be further modified. Thus, for example, cooked hams slide readily past one another, even in the frozen state, in a casing having a PVP impregnation on the outside. The products may thus be handled more readily. In the case of long-keeping or dry sausage, a PVP impregnation on the outside leads to a further increase in cellulase resistance.

The inventive food casing is suitable, in particular, as an artificial sausage casing. Each 5 to 100 m, preferably 25 to 40 m, of the casing can be shirred to form what are called “shirred sticks,” which can then be stuffed with sausage-meat emulsion on placed on an automatic filling machine to be filled. The artificial sausage casing can also readily be fabricated to form sections having a length of generally 10 and 150 cm, to sections tied off at one end (length likewise about 10 to 150 cm) or what are called bundles (length more than 1.5 m to 30 m).

The examples below serve to illustrate the invention. Percentages therein are percentages by weight, unless stated otherwise or obvious from the context.

### EXAMPLE 1

A 19 g hemp fiber paper was shaped to form a tube having a diameter of 60 mm (=caliber 60) and was coated on the outside with viscose and with mixtures of viscose with a 7% strength aqueous PVP-K90 solution. The mixtures were produced in such a manner that the total solids content remained unchanged, that is to say the viscose was decreased by the PVP content. The tubes contained 10%, 20%, 30%, 40% and 50% PVP.

In the case of relatively long production, the spinning speed was increased until the amount of reaction gas and reaction water formed in the tube interior per unit time corresponded to the cellulose content then existing in the viscose.

The tubes passed through the conventional baths and were admixed with glycerol in the last vat, so that the glycerol content in the finished casing was from 20 to 22%.

Before the dryer inlet, a conventional adhesion impregnation solution was charged. The tubes were dried in the inflated state, wound up and, as customary, fabricated to form sections, tied-off sections, and shirred sticks. Some of the more important properties are summarized in the table below:

| Polyvinyl- | Weight | | Permeation | Swelling | Water vapor | Bursting | Static |
|---|---|---|---|---|---|---|---|
| pyrrolidone | per m² | Glycerol | l/m²d at | value | permeability | pressure | extension |
| (PVP) % | g | % | 40 bar | % | g/m²d | kPa | mm at 21 kPa |
| Theoretical | | 22 | | | | 80 | 63.3-66.3 |
| values | | | | | | | |
| 0% | 74.4 | 20 | 100 | 122 | 1511 | 90 | 65.4 |
| (comparison) | | | | | | | |
| 10% | 74.2 | 10 | 91 | 115 | 1814 | 81 | 65.9 |
| 20% | 73.7 | 10 | 82 | 114 | 1856 | 76 | 66.2 |
| 30% | 75.3 | 10 | 64 | 118 | 1822 | 72 | 66.1 |
| 40% | 73.9 | 10 | 54 | 106 | 1870 | 70 | 65.8 |
| 50% | 74.3 | 0 | 46 | 104 | 1878 | 68 | 66 |

Stuffing process, ripening and smoking of long-keeping sausage proceeded normally; the peelability, after ripening for two weeks, was assessed with a score of 2.

### EXAMPLE 2

A 19 g hemp fiber paper was shaped to form a tube of caliber 60 and coated externally and internally with a mixture of 90% viscose and 10% of a 7% strength PVP-K90 solution in water. This was distributed between outside and inside in such a manner that 40% was on the outside and 60% on the inside.

The tube passed through the conventional baths, but only two (instead of 6) reversing rollers in the plasticizer vat, so that the finished tube only contained 15%, instead of 22%, glycerol. The tube, before the dryer inlet, was provided with a conventional adhesion impregnation solution and was dried in the inflated state, wound up and processed into the finished state.

The mechanical properties corresponded to the usual specification; the permeation was 62 l/m²d at 40 bar.

Stuffing process and course of ripening with long-keeping sausage were normal; after ripening for two weeks, the peelability was assessed at 2.5.

### EXAMPLE 3

A 19 g hemp fiber paper was shaped to form a tube of caliber 49 and coated externally with a mixture of 70% viscose and 30% of a 7% strength aqueous PVP-K90 solution. The tube passed through the conventional baths of the spinning machine, but plasticizing with glycerol was omitted.

A conventional adhesion impregnation was applied, the casing was dried in the inflated state, wound up and processed into the finished state. The finished casing had a bursting pressure of 105 kPa (theoretical value: 101 kPa) and a static extension of 51.8 mm at 42 kPa (specification: 51.0 to 53.0 mm at 42 kPa). The swelling value was 105% and the permeation was 38 l/m²d at 40 bar. This is the precondition for very gentle long-keeping sausage ripening without the formation of a dry rim, even under relatively unfavorable ripening conditions.

After ripening for 2 weeks, the peelability was assessed at 2.25.

### EXAMPLE 4

A cellulose-PVP tube of caliber 40 (without fiber web insert) was produced by extruding a solution of 90% viscose and 10% of a 7% strength aqueous PVP-K90 solution through a ring slot die into an acid bath. The tube passed through the conventional baths, was then treated with a plasticizer, and dried in the inflated state. The bursting pressure was 30 kPa, the static extension at 15 kPa was 44 mm.

### EXAMPLE 5

A 19 g hemp fiber paper was shaped to form a tube. The inside of the tube was charged with conventional viscose, but the outside, in contrast, was charged with a mixture of 90% viscose and 10% of a 7% strength aqueous PVP-K90 solution. The quantitative distribution between inside and outside impregnation was 20:80 (based on the weight of the regenerated cellulose or the mixture of regenerated cellulose and PVP).

The tubular casing was, as described in the preceding examples, regenerated, washed, impregnated with plasticizer and dried. It then had a dry weight of 74.1 g/m². The permeation was 86 l/m²d at 40 bar.

The casing could be stuffed with long-keeping sausage-meat emulsion without problems. After ripening for two weeks, the peelability was assessed at 2.5.

### EXAMPLE 6

Example 5 was repeated with the sole difference that the PVP content in the outer viscose was increased to 20%.

It then had a dry weight of 74.1 g/m². The permeation was 75 l/m²d at 40 bar.

The long-keeping sausage produced using this casing showed a pronounced resistance to mold. After inoculating the surface with refined mold spores, the mold growth was markedly reduced and retarded compared with the casing from Example 5. Therefore, this casing was unsuitable for a mold-ripened long-keeping sausage.

### EXAMPLE 7

A 23.7 g hemp fiber paper was shaped to form a tube having a diameter of 100 mm (caliber 100) and was externally coated with viscose. The tube passed, laid-flat, through the conventional spinning, precipitation, wash, desulfurization and plasticizer vats. Thereafter it was run through a roller carrier and coated with an aqueous solution which contained 3% PVP-K90 and 2% glyoxal (based on PVP). As an internal preparation, before the dryer inlet, a release preparation of 0.33% ®Montacell CF, 3% silicone oil emulsion E2 and 2% wax dispersion (40% strength, based on PVP) was charged.

Cooked ham was stuffed into 1.80 m long casings which were tied off at one end. The deep-frozen sausages could slide readily over one another. The casings were very readily peelable.

### EXAMPLE 8

A 19 g hemp fiber paper was shaped to form a tube of caliber 60, was externally coated with viscose and, as usual, was regenerated, washed and plasticized. The gel tube was run over a roller carrier and given a preparation with an aqueous solution which contained 3% PVP-K90 and 3% glyoxal (based on PVP) and 2% wax. As an inner preparation, before the dryer inlet, an aqueous solution of 1.5% casein, 3% glyoxal (based on casein) and 6% ®Aquapel (7.6% strength) was charged.

The tubes were shirred to form shirred sticks and stuffed with long-keeping sausage-meat emulsion. Under unfavorable ripening conditions, that is to say with the formation of cellulytic enzymes, no cellulose breakdown, and thus no reduction in strength of the casings, was observed. They could be peeled off from the sausage very readily and without tearing.

The casing was stuffed with long-keeping sausage-meat emulsion without problems. After ripening for two weeks, the peelability was assessed at 2.5.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined by the appended claims and their equivalents.

The priority document, German Patent Application DE 102 51 200.0 filed Nov. 4, 2002 is incorporated herein by reference in its entirety.

As used herein and in the following claims, articles such as “the”, “a” and “an” can connote the singular or plural.

All documents referred to herein are specifically incorporated herein by reference in their entireties.

What is claimed is:

1. A seamless tubular food casing comprising: at least one vinyl-pyrrolidone homopolymer and/or vinylpyrrolidone copolymer in admixture with cellulose hydrate.

2. A food casing as claimed in claim 1, wherein the weight ratio of vinylpyrrolidone homopolymer and/or vinylpyrrolidone copolymer to cellulose is from 1:25 to 10:1.

3. A food casing as claimed in claim 1, where in the weight ratio of vinylpyrrolidone homopolymer and/or vinylpyrrolidone copolymer is from 1:5 to 5:1.

4. A food casing as claimed in claim 1, where in the weight ratio of vinylpyrrolidone homopolymer and/or vinylpyrrolidone copolymer is from 1:4 to 4:1.

5. A food casing as claimed in claim 1, wherein the vinylpyrrolidone copolymer contains comonomer units of vinyl alkanoate, vinyl alkyl ether, conjugated alkadiene, acrylamide and/or α,β-ethylenically unsaturated carboxylic acid.

6. A food casing as claimed in claim 5, wherein the proportion of comonomer units is less than 50 mol %

7. A food casing as claimed in claim 5, wherein the proportion of comonomer units is less than 30 mol %.

8. A food casing as claimed in claim 1, further comprising a fiber reinforcement.

9. A food casing as claimed in claim 8, wherein the fiber reinforcement comprises a hemp fiber paper.

10. A food casing as claimed in claim 8, wherein the fiber reinforcement comprises a hemp fiber paper and said paper has, on both sides thereof, a cellulose-hydrate-containing layer, and further wherein at least one vinylpyrrolidone homopolymer and/or vinylpyrrolidone copolymer is present in at least one of said cellulose-hydrate layers.

11. A food casing as claimed in claim 10, comprising a cellulose hydrate layer on the outside of the fiber reinforcement containing a vinylpyrrolidone homopolymer and/or vinylpyrrolidone copolymer.

12. A food casing as claimed in claim 1, wherein the content of vinylpyrrolidone homopolymer and/or polyvinylpyrrolidone copolymer is sufficient to inhibit or suppress mold growth.

13. A food casing as claimed in claim 1 having a length from 5 to 100 m and said casing is shirred to form a shirred stick.

14. A process for producing a food casing as claimed in claim 1, comprising:
shaping a reinforcement to form a tube,
charging said tube externally and/or internally with a mixture of viscose and an aqueous solution of a vinylpyrrolidone homopolymer and/or vinyl-pyrrolidone copolymer,
precipitating and regenerating the mixture, and optionally
subsequently washing, plasticizing and drying the casing.

15. An artificial sausage casing comprising a food casing as claimed in claim 1.

16. A dry sausage comprising a food casing as claimed in claim 1.

17. A shirred stick comprising a food casing according to claim 1.

18. A food casing comprising cellulose and an additive, wherein the presence of said additive is in amount sufficient to achieve one or more of the following
as compared to a food casing comprising cellulose without said additive:
(i) lower permeation while water vapor permeability is preserved,
(ii) reduced susceptibility to cellulase and increased resistance to mold, or
(iii) a greater affinity of said casing to sausage-meat emulsion.

19. A food casing according to claim 18, wherein said additive comprises PVP.
